(19) United States
(12) Patent Application Publication
(10) Pub. No.: US 2023/0395004 A1
(43) Pub. Date: Dec. 7, 2023

(54) PROJECTION APPARATUS CONTROLLING LIGHT EMISSION AMOUNT ACCORDING TO PROJECTED IMAGE, CONTROL METHOD OF PROJECTION APPARATUS, AND STORAGE MEDIUM

(71) Applicant: CANON KABUSHIKI KAISHA, Tokyo (JP)

(72) Inventor: Takashi ASAKA, Tokyo (JP)

(21) Appl. No.: 18/325,417

(22) Filed: May 30, 2023

(30) Foreign Application Priority Data
Jun. 7, 2022 (JP) 2022-092364

(51) Int. Cl. G09G 3/00

(52) U.S. Cl. CPC G09G 3/001; G09G 2320/0233; G09G 2320/0626

(57) ABSTRACT

A projection apparatus includes a light source, a processor, and a memory storing a program which, when executed by the processor, causes the projection apparatus to control a light emission amount of the light source, generate an image to be projected via light from the light source, and obtain a setting for brightness of the image to be generated. When the brightness indicated by the obtained setting is less than a predetermined brightness, the program, when executed by the processor, further causes the projection apparatus to generate the image such that a gradation value of the generated image is greater than a value corresponding to the brightness indicated by the setting, and control the light emission amount of the light source such that the light emission amount of the light source is less than a light emission amount corresponding to the brightness.

### BACKGROUND OF THE INVENTION

### Field of the Invention

The present invention relates to a projection apparatus, a control method of the projection apparatus, and a storage medium.

### Description of the Related Art

There is a projection apparatus that projects images includes a normal mode (input image projection mode) for projecting input images as well as a lighting mode for projecting illumination light such as a spotlight.

In the projection apparatus described above, a light valve in a liquid crystal panel or the like is used to form a projection image in both the normal mode and the lighting mode. Thus, a grid-like pattern may show in the projection image. Also, in a dark region in the projection image, black uniformity may be poor due to light bleed from the light valve.

To improve the display quality of a spotlight image, the technique described in International Publication No. 2016/147236 controls a focus lens and blurs a projection image in lighting mode such that the grid-like pattern in the image is less noticeable. However, using this technique, black non-uniformity still remains in the dark regions in the image.

In the lighting mode, using the projection image as the illumination light, a user can adjust the shape and brightness of the spotlight, for example. Thus, when environment where an image is projected is relatively bright, a brighter spotlight may be projected, and when environment where the image is projected in relatively dark or when a bright light is not pointed at a target object where the image is projected, such as a museum, a darker spotlight may be projected.

However, with a known projection apparatus, for example, when the brightness of the spotlight is reduced, black non-uniformity and gradation level differences in the spotlight region become problematically more obvious. Black non-uniformity is caused in this case by light bleed from the light valve being relatively clearly sensed when the darkness of the spotlight region is increased.

Also, when a spotlight region is rendered using only a dark gradation, gradation level differences are caused by expressing the gradation of the spotlight region by using only a few gradations. This is because with dark gradation, an amount of change in the brightness per one gradation is very noticeable, compared to bright gradation.

### SUMMARY OF THE INVENTION

The techniques of the present disclosure have been made in consideration of the aforementioned problems and realize a projection apparatus that suppresses black non-uniformity and gradation level difference when projecting an image.

According to some embodiments, a projection apparatus includes a light source, a processor, and a memory storing a program which, when executed by the processor, causes the projection apparatus to control a light emission amount of the light source, generate an image to be projected via light from the light source, and obtain a setting for brightness of the image to be generated, wherein, when the brightness indicated by the setting that has been obtained is less than a predetermined brightness, the program, when executed by the processor, further causes the projection apparatus to generate the image such that a gradation value of the generated image is greater than a value corresponding to the brightness indicated by the setting, and control the light emission amount of the light source such that the light emission amount of the light source is less than a light emission amount corresponding to the brightness.

According to some embodiments, a control method of a projection apparatus, wherein the projection apparatus includes a light source, a processor, and a memory storing a program which, when executed by the processor, causes the projection apparatus to control a light emission amount of the light source, generate an image to be projected via light from the light source, and obtain a setting for brightness of the image to be generated, and the control method includes when the brightness indicated by the setting that has been obtained is less than a predetermined brightness, generating the image such that a gradation value of the generated image is greater than a value corresponding to the brightness indicated by the setting; and controlling a light emission amount of the light source such that a light emission amount of the light source is less than the light emission amount corresponding to the brightness. Further, according to some embodiments, a non-transitory computer readable medium stores a program, wherein the program causes a computer to execute a control method of a projection apparatus as described above.

Further features of the present invention will become apparent from the following description of exemplary embodiments with reference to the attached drawings.

### BRIEF DESCRIPTION OF THE DRAWINGS

FIG. 1 is a configuration diagram of a projection apparatus according to an embodiment;

FIG. 2 is a flowchart illustrating processing by a projection apparatus according to a first embodiment;

FIG. 3 is a diagram for describing an effect of a spotlight image according to the first embodiment;

FIG. 4 is another diagram for describing an effect of a spotlight image according to the first embodiment;

FIG. 5 is a flowchart illustrating processing by a projection apparatus according to a second embodiment;

FIG. 6 is a flowchart illustrating processing by a projection apparatus according to a third embodiment;

FIG. 7 is a diagram for describing an example of a spotlight image according to a known example;

FIG. 8 is a diagram for describing an example of a spotlight image with a reduced grid-like visual according to a conventional example; and

FIG. 9 is a diagram for describing an example of a spotlight image with low brightness according to a conventional example.

### DESCRIPTION OF THE EMBODIMENTS

An embodiment of the present disclosure will be described below using diagrams. Note that the present disclosure is not limited to the embodiments described below, and modifications can be made, as appropriate, without departing from the spirit of the present disclosure. Also, in the diagrams described below, components with the same function are given the same reference signs, and descriptions thereof are omitted or simplified.

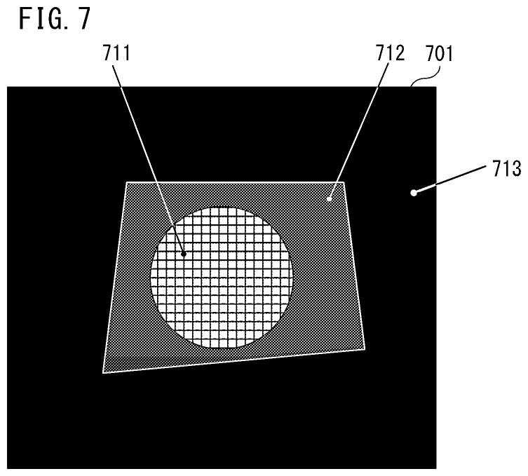

First, a spotlight image projected when using a projection apparatus according to the known technique described above will be described. FIG. 7 illustrates an example of a spotlight image projected using a known projection apparatus. As illustrated in FIG. 7, a spotlight image 701 includes a spotlight region 711, a black non-uniformity region 712, and a surrounding region 713. Note that to facilitate description, the black non-uniformity region 712 is illustrated as a region surrounded by a white line, however the display of the spotlight image actually projected is different, and the white line indicating the region is not displayed. As illustrated in FIG. 7, in the spotlight image 701, the black non-uniformity region 712 is generated in contrast with the darker surrounding region 713 in the image, and a grid-like visual is obvious in the spotlight region 711.

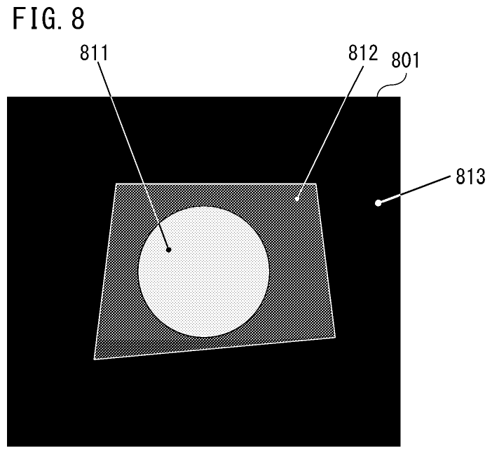

FIG. 8 illustrates an example of a spotlight image projected by a projection apparatus according to a known technique using the technique of blurring the projection image by controlling a focus lens such that the grid-like pattern in the image is less noticeable. As illustrated in FIG. 8, a spotlight image 801 includes a spotlight region 811, a black non-uniformity region 812, and a surrounding region 813. Note that to facilitate description, the black non-uniformity region 812 is illustrated as a region surrounded by a white line, however the display of the spotlight image actually projected is different, and the white line indicating the region is not displayed. As illustrated in FIG. 8, the effect of making the grid-like visual in the spotlight region 811 in the spotlight image 801 less obvious compared to the example in FIG. 7 is achieved. However, the black non-uniformity in the black non-uniformity region 812 remains not suppressed.

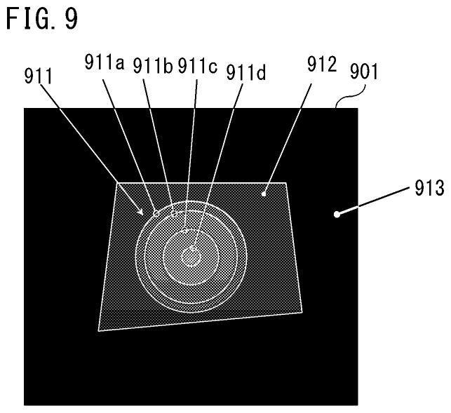

FIG. 9 illustrates an example of a spotlight image projected by a known projection apparatus with the brightness of the spotlight of the projection image reduced. As illustrated in FIG. 9, a spotlight image 901 includes a spotlight region 911, a black non-uniformity region 912, and a surrounding region 913. The spotlight region 911 includes four spotlight regions 911a, 911b, 911c, and 911d of different gradations. Note that to facilitate description, the spotlight regions 911a to 911d and the black non-uniformity region 912 are illustrated as regions surrounded by a white line, however the display of the spotlight image actually projected is different, and the white lines indicating the regions are not displayed. As illustrated in FIG. 9, in this case, the black non-uniformity in the black non-uniformity region 912 is problematically not suppressed, and the gradation level difference in the spotlight region 911 is problematically obvious.

Regarding this, the technique of the present disclosure according to the embodiments described below provides a projection apparatus that can suppress black non-uniformity caused by light bleed by the light valve and gradation level differences in the spotlight region when projecting a spotlight image in particular.

### First Embodiment

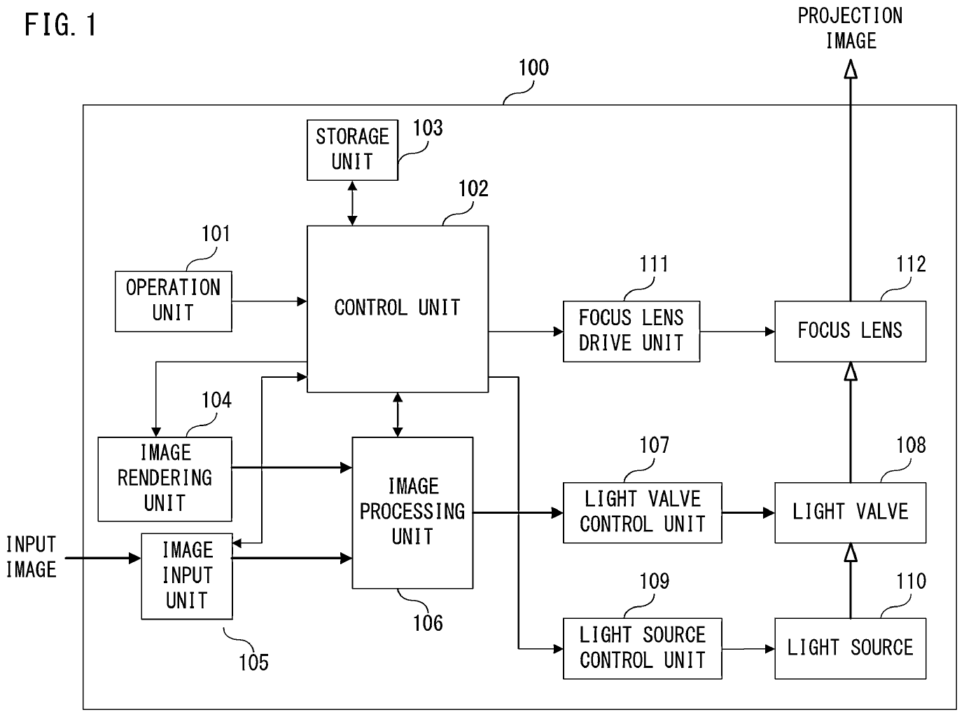

The first embodiment of a technique of the present disclosure will be described below. FIG. 1 is a configuration diagram of a projection apparatus 100 according to the first embodiment. The projection apparatus 100 is a projector including a lighting mode in which a spotlight image is projected and an input image projection mode in which a normal image other than a spotlight is projected.

The user operates an operation unit 101 and selects whether to enable the lighting mode or the input image projection mode for the projection apparatus 100. Examples of the operation unit 101 include a button group provided on a body of the projection apparatus 100, a remote controller using infrared communication, and the like.

In the lighting mode, a control unit 102 receives an operation input from the operation unit 101 and reads out, from a storage unit 103, image data for generating a spotlight image or a function used in generating a spotlight image. Note that the operation unit 101 is an example of an obtaining means for obtaining the settings (specification) for the brightness of the image. The control unit 102 is a Central Processing Unit (CPU) that executes commands and data processing. Also, the storage unit 103 may be a memory element built into the body of the projection apparatus 100 or a detachable memory device such as an SD (registered trademark) card.

The control unit 102 uses an image rendering unit 104 to render a spotlight image using the image data or function read out from the storage unit 103. The image rendering unit 104 is an example of an image generating means for generating an image to be projected via light from a light source. Also, the image rendering processing by the image rendering unit 104 is an example of image generating processing. The spotlight image rendered by the image rendering unit 104 is input to an image processing unit 106.

In the input image projection mode, an image is input into an image input unit 105 from an external device. The input image is sent to the image processing unit 106. The image input unit 105 is constituted by an input terminal such as High-Definition Multimedia Interface (HDMI) (registered trademark), a receiver chip that receives image input signals, and the like. Also, the image input unit 105 notifies the control unit 102 of image information such as the size and frame rate of the input image.

The image processing unit 106 executes image processing on the input image on the basis of control by the control unit 102. For example, the image processing unit 106 executes processing such as gain adjustment of the pixel values of the input image. The image output from the image processing unit 106 is input into a light valve control unit 107. The light valve control unit 107 controls a light valve 108 and generates a projection image. For example, the light valve control unit 107 is a liquid crystal panel driver, and the light valve 108 is a liquid crystal panel.

Also, the control unit 102 controls a light source control unit 109 on the basis of the settings relating to the light source input via the operation unit 101 or the settings relating to the light source stored in the storage unit 103 and controls the light emission amount of a light source 110. The light source control unit 109 is an example of a light source control means for controlling the light emission amount of a light source and is a laser driver, for example. In this case, the light source 110 is a laser beam source or the like.

The light output by the light source 110 is modulated by the light valve 108 to form a projection image. Here, the control unit 102 controls a focus lens drive unit 111 and adjusts the position of a focus lens 112 that determines the projection position of the image to be rendered. For example, the focus lens drive unit 111 is a stepping motor or the like that moves the focus lens 112. In the lighting mode, the control unit 102 controls the focus lens drive unit 111 and changes the focal point of the focus lens 112 to suppress the grid-like pattern caused by the light valve 108 as a second-order effect. In the input image projection mode, the control unit 102 controls the focus lens drive unit 111 and changes the focal point of the focus lens 112 to bring the projection image into focus.

Though not illustrated, the mechanism for adjusting the focus of the projection image is not limited to the focus lens 112. For example, instead of or in addition to changing the focal point of the focus lens 112, a Polymer Dispersed Liquid Crystal (PDLC) may be used that can change the dispersed amount of light according to an applied voltage. In this manner, the dispersed amount of light of the projection image can be increased.

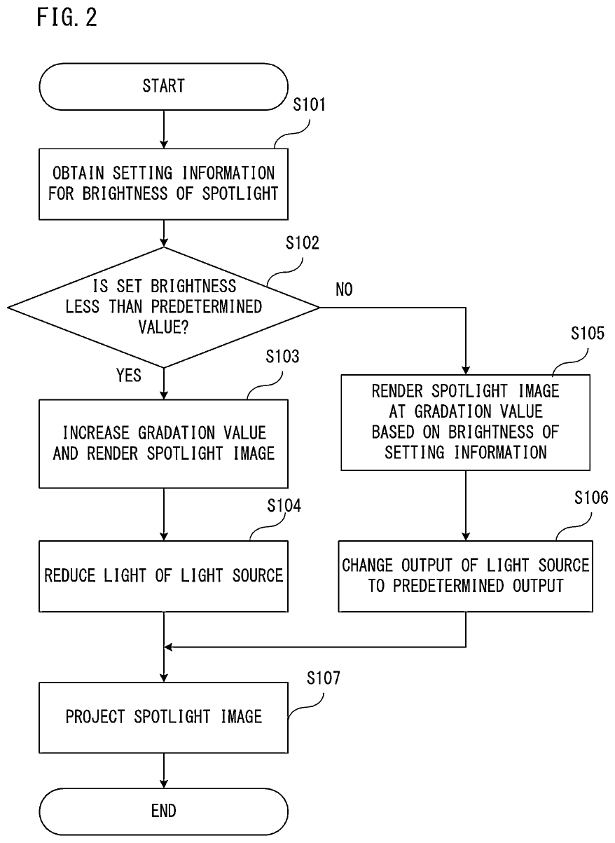

FIG. 2 is a flowchart illustrating the processing executed by the projection apparatus 100. First, in step S101, a user operates the operation unit 101 and inputs an instruction relating to the brightness of the spotlight image to be projected. The control unit 102 obtains setting information for the brightness of the spotlight image on the basis of the instruction received by the operation unit 101.

In step S102, the control unit 102 determines whether or not the brightness of the spotlight image is less than a predetermined brightness on the basis of the setting information obtained in step S101. Here, the brightness of the spotlight image is a parameter for adjusting the brightness of a spotlight image to be projected and is a value ranging from 0 to 100%, for example. Herein, the image stored in the storage unit 103 or the image input into the image input unit 105 is referred to as the original image. In this example the following conditions are used: the output (light emission amount) of the light source 110 is 100%, and the brightness of the spotlight image is 100%. Under these conditions, the illuminance level or the brightness of the image projected onto a screen when the original image is displayed with an aperture ratio of the light valve 108 of 100% corresponds to brightness of 100%.

In the example described below, the user sets the brightness of the spotlight image to 50%. In this example, when the brightness of the spotlight image is set to 50% using only the image processing executed by the image processing unit 106, the aperture ratio of the light valve 108 is adjusted (adjusted to 50% in this example). However, with only the image processing executed by the image processing unit 106, there is a possibility of black non-uniformity being caused in the spotlight image to be projected by light bleed from the light valve. Also, depending on the image, the aperture ratio of the light valve 108 may not reach 100%, and the maximum aperture ratio of the light valve 108 may be 50%, for example. In such a case, when the user sets the brightness to 50% in step S101, the brightness of the spotlight image to be projected is reduced to 25% (assuming that the output of the light source 110 is 100%).

When the value of the brightness indicated by the setting information obtained in step S101 is less than a predetermined value (YES in step S102), the control unit 102 executes the processing of step S103. In step S103, the control unit 102 controls the image rendering unit 104 and renders a spotlight image.

In step S103, the control unit 102 corrects the image data or function used to render the spotlight image. Specifically, the control unit 102 controls the image rendering unit 104 and renders the spotlight image at a higher gradation value than a gradation value based on the product of the image data or function used to render the spotlight image and the brightness set by the user. Accordingly, the image rendering unit 104 generates an image such that the gradation values of the image to be generated are greater than the values corresponding to the brightness specified by the user. Here, the gradation values used in rendering the spotlight image are in a proportional relationship with the aperture ratio of the light valve 108.

Via the processing of step S103, the gradation that can be used in rendering the spotlight image can be prevented from deviating too much toward a low gradation, and the types of gradation in relatively dark regions in the spotlight image can be prevented from being too few. As a result, according to the projection apparatus 100 of the present embodiment, a smooth spotlight image with suppressed gradation level differences can be rendered and projected.

Then, in step S104, the control unit 102 controls the light source control unit 109 and reduces the light from the light source 110. Specifically, the light emission amount of the light source is controlled by the light source control unit 109 to reduce the light emission amount of the light source to a light emission amount less than the light emission amount corresponding to the brightness specified by the user. In the case of the example described above, by the control unit 102 reducing the output of the light source 110 to 25%, a spotlight image with the brightness desired by the user can be projected, and the effect of suppressing black non-uniformity in the spotlight image from reducing the light from the light source 110 can be obtained.

On the other hand, when the value of the brightness indicated by the setting information obtained in step S101 is equal to or greater than the predetermined value (NO in step S102), the control unit 102 executes the processing of step S105. In step S105, the control unit 102 controls the image rendering unit 104 and renders a spotlight image with gradation values based on the brightness set by the user. Here, the predetermined value used to determine the brightness in step S102 is a threshold for starting light source control. Note that in the rendering processing of step S105, the brightness of the original image may be changed using only the image processing executed by the image processing unit 106, and the aperture ratio of the light valve 108 may be adjusted.

Then, in step S106, the control unit 102 controls the light source control unit 109 and sets the output of the light source 110 as a predetermined output (for example, a light emission amount of 100%). Note that when the user operates the operation unit 101 and changes the predetermined light source output, the light source control unit 109 changes to the light source output set by the user.

In the example described below of the brightness of the spotlight image to be projected, the brightness set by the user in step S101 is changed when the brightness of the original image of the spotlight image is 50% and the predetermined value described above is 50%.

When the brightness set by the user in step S101 is in a range from 50% to 100%, the control unit 102, after the determination in step S102, executes the processing of step S105. At this time, the product (aperture ratio of the light valve 108) of the brightness (50%) of the original image and the brightness (50% to 100%) set by the user is in a range from 25% to 50%. The brightness of the spotlight image to be projected is determined from the product of the aperture ratio of the light valve 108 and the output of the light source 110. Accordingly, when the output of the light source 110 is 100% in step S106, the brightness of the spotlight image to be projected is in a range from 25% to 50%.

On the other hand, when the brightness set by the user in step S101 is less than 50%, the control unit 102, after the determination in step S102, executes the processing of step S103. In step S103, the control unit 102 increases the brightness of the original image from 50% to 100%. Also, in step S104, to counteract the brightness (50%) set by the user and the amount of change (+50%) in the brightness of the original image in step S103, the control unit 102 reduces the light from the light source 110, changing the output from 100% to 25%. As a result, the brightness of the spotlight image to be projected is made a brightness less than 25%.

After the processing of step S104 or step S106 described above has been executed, the control unit 102 executes the processing of step S107. In step S107, the control unit 102 causes the light source 110 to emit light at the output set by the light source control unit 109 and sets the spotlight image rendered by the image rendering unit 104 at the light valve 108. Then, the control unit 102 modulates the light from the light source 110 and projects the spotlight image with the brightness desired by the user on a screen.

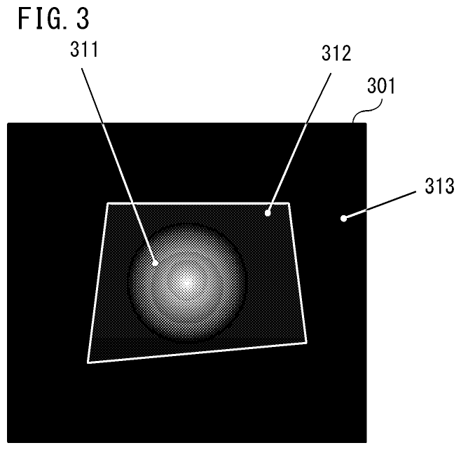

FIG. 3 is a diagram for describing the effect obtained when rendering a spotlight image with low brightness according to the first embodiment. As illustrated in FIG. 3, a spotlight image 301 includes a spotlight region 311, a black non-uniformity region 312, and a surrounding region 313. Note that to facilitate description, the black non-uniformity region 312 is illustrated as a region surrounded by a white line, however the display of the spotlight image actually projected is different, and the white line indicating the region is not displayed. Since the light source 110 has reduced light, as illustrated in the black non-uniformity region 312, black non-uniformity caused by light bleed from the light valve 108 is suppressed. Furthermore, the gradation range that can be used by the image rendering unit 104 is not narrowed as in the case of using known techniques, and gradation level differences are suppressed in the spotlight image.

Also, in the present embodiment, another method of suppressing gradation level differences in the spotlight image may be used in which a solid spotlight image of a single gradation is rendered instead of displaying the gradations of the spotlight image. In this case, in step S103 of the flowchart in FIG. 2, the control unit 102 corrects the image data or function by using the gradations when the aperture ratio of the light valve 108 is at a peak and rendering a spotlight image displaying a solid spotlight region.

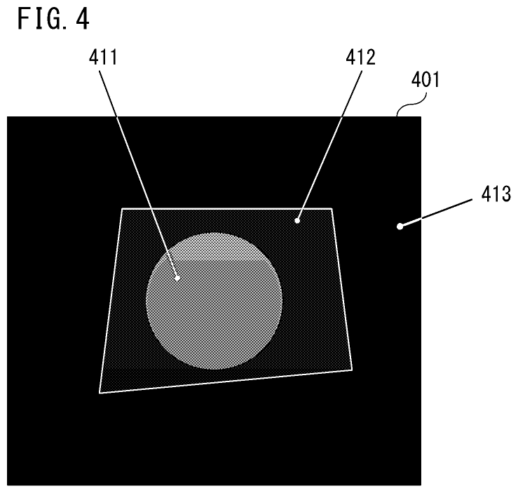

FIG. 4 is a diagram for describing the effect obtained when rendering a solid spotlight region in a spotlight image according to the first embodiment. As illustrated in FIG. 4, a spotlight image 401 includes a spotlight region 411, a black non-uniformity region 412, and a surrounding region 413. Note that to facilitate description, the black non-uniformity region 412 is illustrated as a region surrounded by a white line, however the display of the spotlight image actually projected is different, and the white line indicating the region is not displayed. As a result, as illustrated in FIG. 4, in the spotlight image 401 to be projected, black non-uniformity is suppressed as illustrated in the black non-uniformity region 412, and gradation level differences are suppressed by making the spotlight region 411 solid.

As describe above, according to the present embodiment, black non-uniformity in the spotlight image to be projected and gradation level differences in the spotlight region can be suppressed.

### Second Embodiment

In the first embodiment, the control unit 102 corrects the spotlight image rendered using the image rendering unit 104 and reduces the light of the light source 110. This suppresses black non-uniformity when a spotlight image is projected with low brightness and suppresses gradation level differences in a spotlight region. In the present embodiment, the spotlight image rendered using the image rendering unit 104 is corrected by the image processing unit 106 and the light of the light source 110 is reduced by the control unit 102. This suppresses black non-uniformity when a spotlight image is projected with low brightness and suppresses gradation level differences in a spotlight region. Note that hereinafter, configurations and processing that are similar to the configurations and processing in the first embodiment will be given the same reference sign and detail descriptions thereof will be omitted.

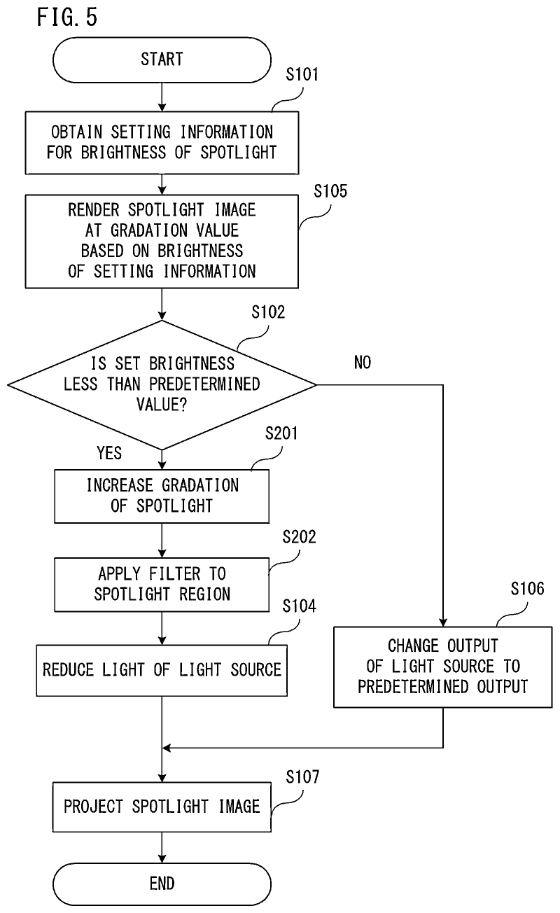

FIG. 5 is a flowchart illustrating the processing executed by the projection apparatus 100 according to the second embodiment. Note that processing similar to the processing of the flowchart in FIG. 2 will be given the same reference sign.

In step S101, a user operates the operation unit 101 and inputs an instruction relating to the brightness of the spotlight image to be projected. The control unit 102 obtains setting information for the brightness of the spotlight image on the basis of the instruction received by the operation unit 101.

Next, in step S105, the control unit 102 controls the image rendering unit 104 and renders a spotlight with gradation values based on the brightness setting. Then, in step S102, the control unit 102 determines whether or not the brightness of the spotlight image is less than a predetermined brightness on the basis of the setting information obtained in step S101.

When the value of the brightness indicated by the setting information obtained in step S101 is less than a predetermined value (YES in step S102), the control unit 102 executes the processing of step S201. In step S201, the control unit 102 controls the image processing unit 106 and renders a spotlight image with gradation values based on the brightness set by the user. In this example, a spotlight image is projected with the aperture ratio of the light valve 108 being 50% and the output of the light source 110 being 100%. At this time, the brightness of the spotlight image is determined from the product of the aperture ratio of the light valve 108 and the output of the light source 110. Accordingly, when the output of the light source 110 is reduced to 50%, even by setting the aperture ratio of the light valve 108 to 100%, a spotlight image with the same brightness can be projected.

In step S201, the control unit 102 controls the image processing unit 106 and increases the gradation value of the spotlight image via gain adjustment and changes the aperture ratio of the light valve 108 from 50% to 100%. As a result, the gradation that can be used in rendering the spotlight image can be prevented from deviating too much toward a low gradation, and the types of gradation in relatively dark regions in the spotlight image can be prevented from being too few. However, in the processing described above, since gain adjustment is simply uniformly performed on the gradation of the spotlight image, the gradation level differences in the spotlight region remain.

Next, the control unit 102 executes the processing of step S202. Specifically, the control unit 102 controls the image processing unit 106 and executes processing on the spotlight image with increased gradation values due to the gain adjustment in step S201 to blur the boundaries between gradations to make the gradation level differences less obvious. For example, the control unit 102 moves and diffuse the positions of the pixels at the boundary between gradation level differences in the spotlight image such that the gradation level differences are made less obvious. Alternatively, the control unit 102 executes filter processing including Gaussian diffusion at the boundary portion of the gradation level differences in the spotlight image to change the diffusion amount of light in the spotlight image. Here, the control unit 102 functions as a diffusing means for changing the diffusion amount of light in the image to be generated. In this manner, a smooth spotlight can be rendered with suppressed gradation level differences in the spotlight region in the spotlight image to be projected. After the processing of step S202, the control unit 102 executes the processing of step S104, controls the light source control unit 109, and reduces the output of the light source 110 to reduce the light of the light source 110.

On the other hand, when the brightness set by the user in step S102 is greater than a predetermined value (NO in step S102), the control unit 102 executes the processing of step S106, controls the light source control unit 109, and sets the output of the light source 110 as a predetermined output (for example, a light emission amount of 100%). Note that when the user operates the operation unit 101 and changes the predetermined light source output, the light source control unit 109 changes to the light source output set by the user.

After the processing of step S104 or step S106 described above has been executed, the control unit 102 executes the processing of step S107. In step S107, the control unit 102 causes the light source 110 to emit light at the output set by the light source control unit 109 and sets the spotlight image rendered by the image rendering unit 104 at the light valve 108. Then, the control unit 102 modulates the light from the light source 110 and projects the spotlight image with the brightness desired by the user on a screen.

As describe above, according to the present embodiment, black non-uniformity in the spotlight image to be projected and gradation level differences in the spotlight region can be suppressed.

### Third Embodiment

In the second embodiment, the spotlight image rendered using the image rendering unit 104 is corrected by the image processing unit 106 and the light of the light source 110 is reduced by the control unit 102. This suppresses black non-uniformity when a spotlight image is projected with low brightness and suppresses gradation level differences in a spotlight region. In the present embodiment, the spotlight image with gradation adjusted by applying gain at the image processing unit 106 is blurred using the focus lens 112, and the light of the light source 110 is reduced. This suppresses black non-uniformity when a spotlight image is projected with low brightness and suppresses gradation level differences in a spotlight region. Note that hereinafter, configurations and processing that are similar to the configurations and processing in the first embodiment will be given the same reference sign and detail descriptions thereof will be omitted.

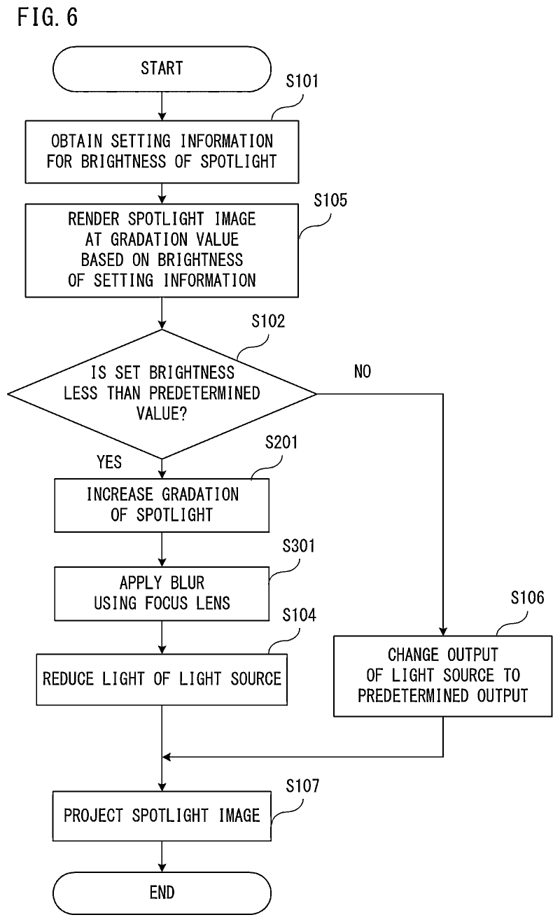

FIG. 6 is a flowchart illustrating the processing executed by the projection apparatus 100 according to the third embodiment. Note that processing similar to the processing of the flowchart in FIG. 5 will be given the same reference sign.

In step S101, a user operates the operation unit 101 and inputs an instruction relating to the brightness of the spotlight image to be projected. The control unit 102 obtains setting information for the brightness of the spotlight image on the basis of the instruction received by the operation unit 101.

Next, in step S105, the control unit 102 controls the image rendering unit 104 and renders a spotlight with gradation values based on the brightness setting. Then, in step S102, the control unit 102 determines whether or not the brightness of the spotlight image is less than a predetermined brightness on the basis of the setting information obtained in step S101.

When the value of the brightness indicated by the setting information obtained in step S101 is less than a predetermined value (YES in step S102), the control unit 102 executes the processing of step S201. In step S201, the control unit 102 controls the image processing unit 106 and increases the gradation value of the spotlight image via gain adjustment and changes the aperture ratio of the light valve 108 from 50% to 100%. As a result, the gradation that can be used in rendering the spotlight image can be prevented from deviating too much toward a low gradation, and the types of gradation in relatively dark regions in the spotlight image can be prevented from being too few. However, in the processing described above, since gain adjustment is simply uniformly performed on the gradation of the spotlight image, the gradation level differences in the spotlight region remain.

Next, the control unit 102 executes the processing of step S301. In step S301, the control unit 102 controls the focus lens drive unit 111, moves the focus lens 112, and applies a stronger blur than the blur for reducing the grid-like visual to make the gradation level differences in the spotlight image to be projected less obvious. Also, as described above, the PDLC is used to apply a blur to the spotlight image to be projected and make the gradation level differences less obvious. Note that when the maximum blur is already applied by the PDLC when starting the processing of step S301, a second PDLC may be used to apply a blur. Here, the control unit 102, as a diffusing means, changes the diffusion amount of light in the image to be generated. In this manner, a smooth spotlight with suppressed gradation level differences can be rendered.

After the processing of step S301, the control unit 102 executes the processing of step S104, controls the light source control unit 109, and reduces the output of the light source 110 to reduce the light of the light source 110.

On the other hand, when the brightness set by the user in step S102 is greater than a predetermined value (NO in step S102), the control unit 102 executes the processing of step S106, controls the light source control unit 109, and sets the output of the light source 110 as a predetermined output (for example, a light emission amount of 100%). Note that when the user operates the operation unit 101 and changes the predetermined light source output, the light source control unit 109 changes to the light source output set by the user.

After the processing of step S104 or step S106 described above has been executed, the control unit 102 executes the processing of step S107. In step S107, the control unit 102 causes the light source 110 to emit light at the output set by the light source control unit 109 and sets the spotlight image rendered by the image rendering unit 104 at the light valve 108. Then, the control unit 102 modulates the light from the light source 110 and projects the spotlight image with the brightness desired by the user on a screen.

As describe above, according to the present embodiment, black non-uniformity in the spotlight image to be projected and gradation level differences in the spotlight region can be suppressed.

Preferred embodiments of a projection apparatus according to the present disclosure have been described above. However, the present disclosure is not limited to these specific embodiments and include various embodiments without departing from the spirit of the techniques of the present disclosure. Also, the embodiments described above can be combined as appropriate with one another.

Also, a software program for implementing the functions of the embodiments described above being supplied to a system or an apparatus including a computer capable of executing the program directly from a recording medium or via wired or wireless communication and being executed is also included in the present invention. Accordingly, because the functional processing of the present invention is implemented using a computer, a program supplied to the computer and installed also may implement the present invention. In other words, a computer program for implementing the functional processing of the present invention is included in the present invention. In this case, as long as the functions of the program are provided, the object code, the program executed by the interpreter, the script data supplied to the OS, or any similar program form can be used. For the recording medium for supplying the program, for example, a magnetic recording medium such as a hard disk or magnetic tape, an optical or magneto-optical recording medium, or a non-volatile semiconductor memory may be used. Also, a plausible method for supplying the program includes storing the computer program for implementing the present invention on a server on a computer network and a connected client computer downloading the computer program.

Note that the functional units of each embodiment (modified example) described above may or may not be individual pieces of hardware. The functions of two or more functional units may be implemented by a common piece of hardware. Each one of a plurality of functions of one functional unit may be implemented by individual pieces of hardware. Two or more functions of one functional unit may be implemented by a common piece of hardware. Also, the functional units may or may not be implemented by hardware such as ASIC, FPGA, DSP, or the like. For example, the apparatus may include a processor and a memory (storage medium) storing a control program. Also, the function of at least one or more functional units in the apparatus may be implemented by the processor reading out the control program from the memory and executing the control program.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to a projection apparatus according to a technique of the present disclosure, black non-uniformity and gradation level differences can be suppressed when projecting an image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-092364, filed on Jun. 7, 2022, which is hereby incorporated by reference herein in its entirety.

What is claimed is:

1. A projection apparatus, comprising:
a light source;
a processor; and
a memory storing a program which, when executed by the processor, causes the projection apparatus to
control a light emission amount of the light source,
generate an image to be projected via light from the light source, and
obtain a setting for brightness of the image to be generated,
wherein, when the brightness indicated by the setting that has been obtained is less than a predetermined brightness, the program, when executed by the processor, further causes the projection apparatus to
generate the image such that a gradation value of the generated image is greater than a value corresponding to the brightness indicated by the setting, and
control the light emission amount of the light source such that the light emission amount of the light source is less than a light emission amount corresponding to the brightness.

2. The projection apparatus according to claim 1, wherein
when the brightness indicated by the setting that has been obtained is less than the predetermined brightness, the program, when executed by the processor, further causes the projection apparatus to
correct a function used in generating the image and change a gradation of the generated image.

3. The projection apparatus according to claim 1, wherein
when the brightness indicated by the setting that has been obtained is less than the predetermined brightness, the program, when executed by the processor, further causes the projection apparatus to
change a gradation of the generated image by removing a gradation level difference in the generated image.

4. The projection apparatus according to claim 1, wherein
when the brightness indicated by the setting that has been obtained is less than the predetermined brightness, the program, when executed by the processor, further causes the projection apparatus to change a diffusion amount of light in the generated image.

5. The projection apparatus according to claim 4, wherein
the program, when executed by the processor, further causes the projection apparatus to move and diffuse positions of pixels at a boundary of a gradation level difference in the generated image, and change a diffusion amount of a light in the generated image.

6. The projection apparatus according to claim 4, wherein
the program, when executed by the processor, further causes the projection apparatus to change a diffusion amount of light in the generated image by executing filter processing including Gaussian diffusion at a boundary portion of a gradation level difference in the generated image.

7. The projection apparatus according to claim 4, further comprising:
a focus lens that determines a projection position of the generated image,
wherein the program, when executed by the processor, further causes the projection apparatus to change a diffusion amount of light in the generated image by moving the focus lens.

8. The projection apparatus according to claim 4, further comprising:
polymer disperse liquid crystal (PDLC) that changes a diffusion amount of the light in the generated image,
wherein the program, when executed by the processor, further causes the projection apparatus to change a diffusion amount of light in the generated image by changing a diffusion amount of the light from the PDLC.

9. A control method of a projection apparatus,
wherein the projection apparatus includes a light source, a processor, and a memory storing a program which, when executed by the processor, causes the projection apparatus to
control a light emission amount of the light source,
generate an image to be projected via light from the light source, and
obtain a setting for brightness of the image to be generated, and
the control method comprising:
when the brightness indicated by the setting that has been obtained is less than a predetermined brightness,
generating the image such that a gradation value of the generated image is greater than a value corresponding to the brightness indicated by the setting; and
controlling a light emission amount of the light source such that a light emission amount of the light source is less than the light emission amount corresponding to the brightness.

10. A non-transitory computer readable medium that stores a program, wherein the program causes a computer to execute a control method of a projection apparatus,
wherein the projection apparatus includes a light source, a processor, and a memory storing a program which, when executed by the processor, causes the projection apparatus to
control a light emission amount of the light source,
generate an image to be projected via light from the light source, and
obtain a setting for brightness of the image to be generated, and
the control method includes:
when the brightness indicated by the setting that has been obtained is less than a predetermined brightness,
generating the image such that a gradation value of the generated image is greater than a value corresponding to the brightness indicated by the setting; and
controlling a light emission amount of the light source such that a light emission amount of the light source is less than the light emission amount corresponding to the brightness.
